(19) United States
(12) Patent Application Publication
(10) Pub. No.: US 2015/0320251 A1
(43) Pub. Date: Nov. 12, 2015

(54) FOOD COOKING DEVICE

(71) Applicant: La Kaffa International Co., Ltd., Hsinchu Country (TW)

(72) Inventor: Yao-Hui WANG, Hsinchu County (TW)

(21) Appl. No.: 14/324,094

(22) Filed: Jul. 4, 2014

(30) Foreign Application Priority Data
May 9, 2014 (TW) 103208155

(51) Int. Cl. A47J 27/10

(52) U.S. Cl. CPC A47J 27/10

(57) ABSTRACT

A food cooking device includes a machine body having an enclosure and an interior container, wherein the enclosure is provided with an electric heater and a motor mixer, and the interior container is removably combined to a mixing shaft of the motor mixer and positioned in the accommodation reservoir; a water inlet pipe and a water inlet control valve thereof, communicated with the accommodation reservoir; an ambient temperature sensor disposed outside the machine body; an inner temperature sensor, disposed in the machine body; and a controller electrically connected to the electric heater, motor mixer, ambient temperature sensor, inner temperature sensor, and water inlet control valve, for determining a calculated proportional relationship between water and food depending on the external ambient temperature, and controlling the weight or volume of the water entering the accommodation reservoir.

### RELATED APPLICATIONS

This application claims priority to Taiwan Application Serial Number 103208155, filed May 9, 2014, which is herein incorporated by reference.

### BACKGROUND

1. Field of Invention

The invention relates to a food cooking device, and particularly to a cooking device applied for cooking a food by boiling water twice.

2. Description of Related Art

Different foods have many different kinds of cooking manners. For cooking of starchy or flour food (hereafter also referred to food for short) such as Tapioca balls, dumplings and the like, generally these foods are put into water after the water is boiled, and then the water and foods are heated until the water is boiled for the second time; then some cold water is added for cooling; and thereafter the water is boiled again; wherein the step is repeated for many times depending on properties of the food. This is because if the starchy or flour food is put into the low-temperature water at an initial stage for cooking the food for the first time, the food will be gelatinized in the water and thus cannot be cooked continually. To avoid such a case, the food is put into the boiling water for the first time. When the food is heated in water until the water is boiled for the second time, to avoid undercooked condition inside the food or very different inner and outer tastes of the food, the foods are simmered for a period of time for some cold water is added to reduce the temperature and then the water is boiled again); then cold water is added for cooling; and thereafter the food is taken out for eating or storing.

In the past, often a general pot is used as a cooking device of a starchy or flour food, wherein various operations of the process is mainly performed manually, being extremely inconvenient, and the heating time and the ratio between the water and food are all determined empirically, such that it cannot get a congruous cooking taste.

More particularly, during the process of cooking the starchy or flour food, the ratio between the water and the food is very important, which affects the taste of the food. When the room temperature is varied too significantly, the effect to the taste is higher. This is because when the food is added after the water is boiled for the first time, the reduction level of water temperature is directly affected, under the same heating power, the cooking time for bring the water to boil again varies, which affects the final taste of the cooked food and cannot keep the food quality for each cooking. For example, Compared with a standard room temperature 20° C. condition for cooking foods and water, when the room temperature is 10° C. a constant amount of food stored at the room temperature is added into the boiling water for the first time; then the temperature of water may be reduced to about 75° C.; and the water is heated from 75° C. to 100° C. to cook foods as boiling for the second time; however, during the heating process from 75° C. to 100° C., the heating time of food is relatively longer and will cause a soft taste of the cooked food finally. In contrast, when the room temperature is 30° C., a same constant amount of food stored at the room temperature is added into the boiling water for the first time; then the temperature of water may be only reduced to about 85° C.; and the water is heated from 85° C. to 100° C. to cook foods as boiling for the second time; however, during the heating process from 85° C. to 100° C., the heating time of food is relatively shorter and will cause a hard taste of the cooked food finally.

Hence, it can be seen that the conventional cooking device of the starchy or flour food is inconvenient for operation and cannot obtain a congruous taste quality for each cooking.

### SUMMARY

The invention provides a food cooking device, which is convenient in operation and can obtain constant cooking quality and taste quality for each cooking.

According to an aspect of the invention, a food cooking device is provided, applied for cooking a food by boiling water twice. The food cooking device includes a machine body with an enclosure and an interior container, wherein an electric heater is arranged on the wall body of the enclosure, and an accommodation reservoir is formed at the inner portions of the enclosure for accommodating water, and a motor mixer is disposed at the bottom of the enclosure, the motor mixer has a mixing shaft perpendicularly protruded towards the central part of the accommodation reservoir, the interior container is removably combined with the mixing shaft and is disposed in the accommodation reservoir, an accommodation chamber is formed at the inner portion of the interior container for accommodating the food, and multiple through holes are formed on the wall body of the interior container and communicated with the accommodation reservoir and the accommodation chamber; a water inlet pipe and a water inlet control valve thereof, communicated with the accommodation reservoir, for transferring the water into the accommodation reservoir; an ambient temperature sensor disposed outside the machine body for sensing the room ambient temperature; an inner temperature sensor, disposed in the machine body for sensing the inner temperature of the machine body; and a controller electrically connected to the electric heater, the motor mixer, the ambient temperature sensor, the inner temperature sensor, and the water inlet control valve, so as to determine a calculated proportional relationship between water and food depending on the external ambient temperature, and to control the weight or volume of the water incoming the accommodation reservoir from the water inlet pipe according to the proportional relationship and the weight or volume of the food.

According to an embodiment of the invention, the water inlet pipe is provided with a water inlet pressure sensor and a water inlet flow regulator, wherein the water inlet pressure sensor and the water inlet flow regulator are electrically connected to the controller.

According to an embodiment of the invention, the water inlet pipe is a hot-water inlet pipe.

According to an embodiment of the invention, the food cooking device further includes a water outlet pipe and a water outlet control valve of the pipe, wherein the water outlet pipe is communicated with the bottom of the accommodation reservoir, and the water outlet control valve is electrically connected to the controller.

According to an embodiment of the invention, a recess is arranged at the bottom of the accommodation reservoir and communicated with the water outlet pipe, for accommodating a removable residue collecting container.

According to an embodiment of the invention, the food cooking device further includes a cold water inlet pipe and a cold-water inlet control valve of the pipe, wherein the cold water inlet pipe is communicated with the accommodation reservoir, and the cold-water inlet control valve is electrically connected to the controller.

According to an embodiment of the invention, the cold water inlet pipe is provided with a cold-water inlet pressure sensor and a cold-water inlet flow regulator, wherein the cold-water inlet pressure sensor and the cold-water inlet flow regulator are electrically connected to the controller.

According to an embodiment of the invention, an operable lid body covers the top surface of the enclosure.

The food cooking device according to an embodiment of the invention is convenient in operation, and for a food required to be cooked by boiling water twice, the device can ensure the heating time of the food is constant, not changing the heating time of the food due to the extremely significant varying of the room ambient temperature.

### BRIEF DESCRIPTION OF THE DRAWINGS

FIG. 1 is an outside view of a food cooking device according to an embodiment of the invention.

FIG. 2 is a cross-sectional view of the food cooking device shown in FIG. 1.

FIG. 3 is a control block view of the food cooking device shown in FIG. 1.

FIG. 4 is a first schematic using view of the food cooking device shown in FIG. 2.

FIG. 5 is a second schematic using view of the food cooking device shown in FIG. 2.

FIG. 6 is a third schematic using view of the food cooking device shown in FIG. 2.

FIG. 7 is a fourth schematic using view of the food cooking device shown in FIG. 2.

### DESCRIPTION OF THE EMBODIMENTS

The foregoing and other technical contents, features and functions of the invention will be clearly presented through the following detailed description of embodiments with reference to the accompanying drawings.

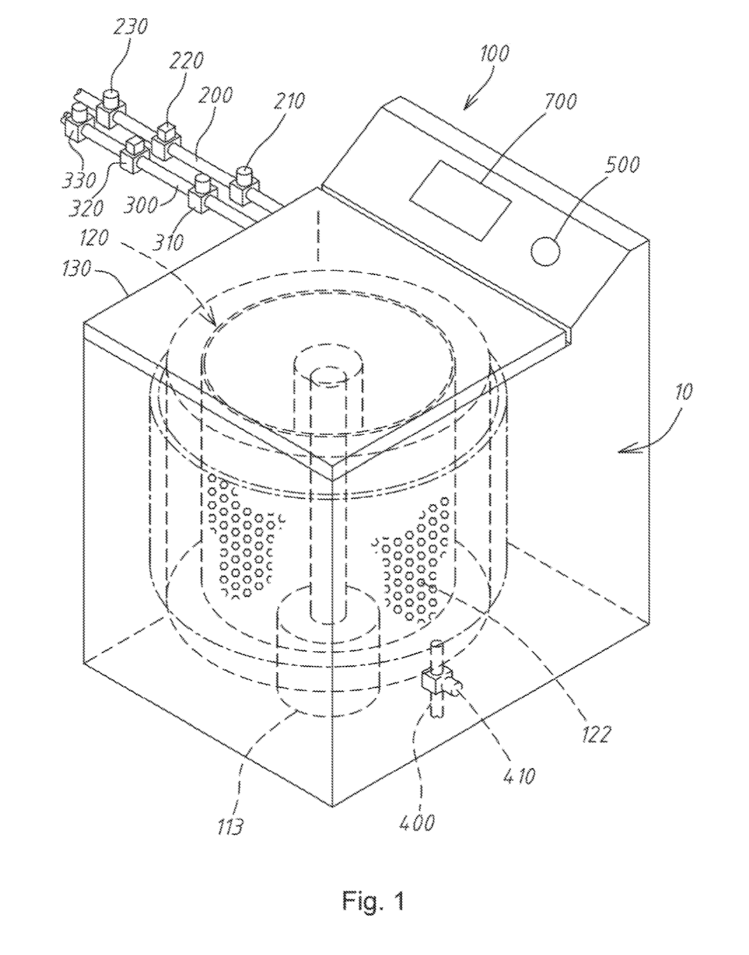

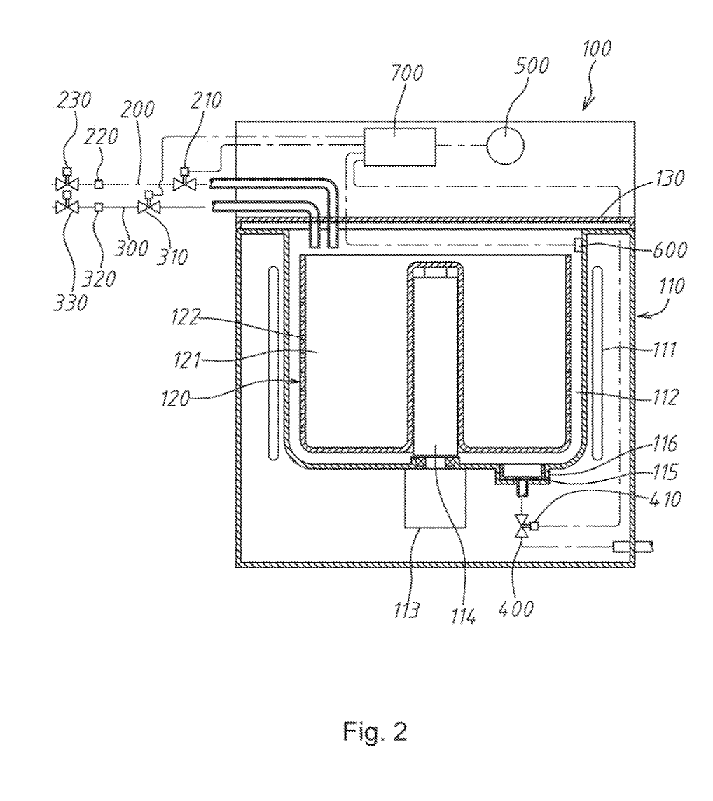

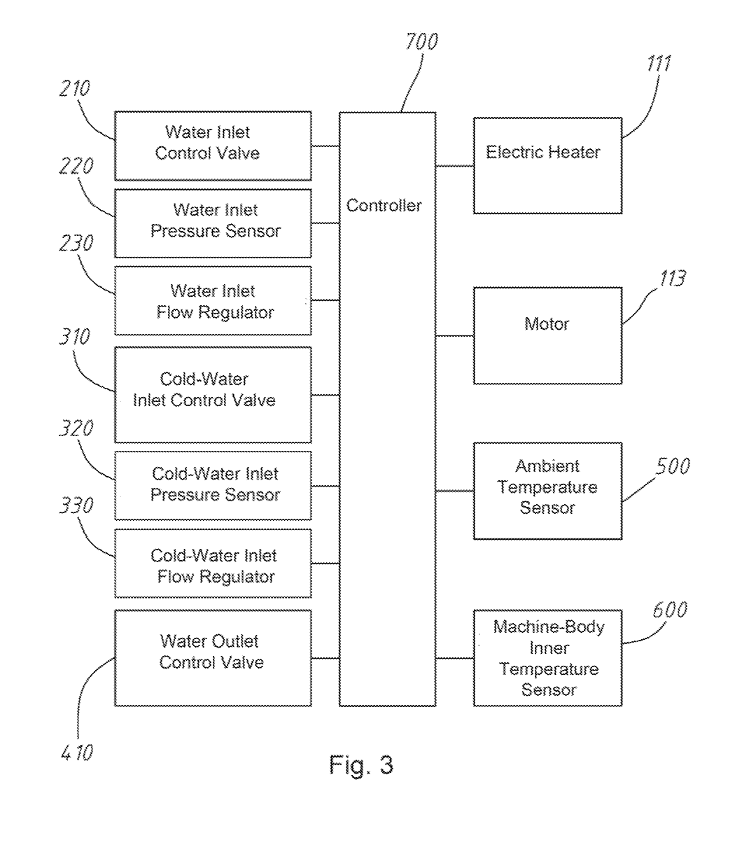

Referring to FIGS. 1-3, the food cooking device according to an embodiment of the invention is applied for cooking starchy or flour food (hereafter also referred to food for short) by boiling water twice. The food cooking device includes a machine body 100, a water inlet pipe 200, a cold water inlet pipe 300, a water outlet pipe 400, an ambient temperature sensor 500, an inner temperature sensor 600, and a controller 700.

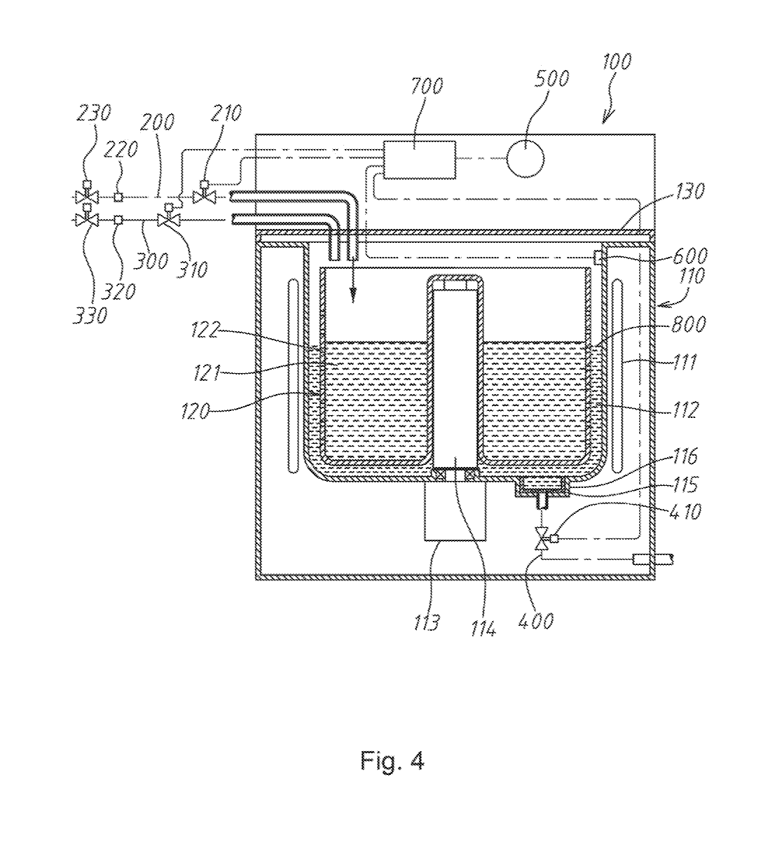

The machine body 100 includes an enclosure 110 and an interior container 120. An electric heater 111 is arranged on the wall body of the enclosure 110; an accommodation reservoir 112 is formed on the inner portion of the enclosure 110 for accommodating water 800 (as shown in FIG. 4); and a motor mixer 113 is arranged at the bottom of the enclosure 110, having a mixing shaft 114 perpendicularly protruded towards the central portion of the accommodation reservoir 112; and additionally an openable lid body 130 covers the top surface of the enclosure 110. The interior container 120 is removably combined to the mixing shaft 114, and is located in the accommodation reservoir 112 of the enclosure 110; an accommodation chamber 121 is formed on the inner portion of the interior container 120 for accommodating a food 900 (as shown in FIG. 4); multiple through holes 122 are formed on the wall body of the interior container 120, which are communicated with the accommodation reservoir 112 and the accommodation chamber 121. Hence, the water 800 heated by the electric heater 111 can heat the food 900 accommodated in the accommodation chamber 121 via the through holes 122, and the motor mixer 113 can drive the interior container 120 to rotate, so as to mix the food 900 with uniform heat.

The water inlet pipe 200 is communicated with the accommodation reservoir 112, for transferring the water 800 into the accommodation reservoir 112 of the enclosure 110. The water inlet pipe 200 is provided with a water inlet control valve 210, a water inlet pressure sensor 220, and a water inlet flow regulator 230. The water inlet control valve 210 can control whether the water incomes from the water inlet pipe 200 or not. The water inlet pressure sensor 220 can sense the inlet-water pressure in the water inlet pipe, and the water inlet flow regulator 230 can regulate the flow of the inlet water in the water inlet pipe. The water inlet pipe 200 is a hot-water inlet pipe, which can reduce the heating time of the water 800 in the accommodation reservoir 112.

The cold water inlet pipe 300 is also communicated with the accommodation reservoir 112, for transferring the cold water into the accommodation reservoir 112 of the enclosure 110, so as to cool the food 900 after fully cooked. The cold water inlet pipe 300 is provided with a cold-water inlet control valve 310 a cold-water inlet pressure sensor 320, and a cold-water inlet flow regulator 330. The cold-water inlet control valve 310 can control whether the water incomes from the cold water inlet pipe 300 or not. The cold-water inlet pressure sensor 320 can sense the pressure of the cold water in the cold water inlet pipe, and the cold-water inlet flow regulator 330 can regulate the flow of the cold water in the cold water inlet pipe.

The water outlet pipe 400 is communicated to the bottom of the accommodation reservoir 112, for evacuating water. The water outlet pipe 400 is provided with a water outlet control valve 410 used for controlling whether to evaluate water through the water outlet pipe 400 or not. A recess 115 is disposed at the bottom of the accommodation reservoir 112. The water outlet pipe 400 is communicated to the recess 115 disposed at the bottom of the accommodation reservoir 112, and the recess 115 accommodates a removable residue collecting container 116 for collecting possible residues generated during cooking of the food 900.

The ambient temperature sensor 500 is disposed′ outside the machine body 100, so as to sense the room ambient temperature. The inner temperature sensor 600 is disposed in the machine body 100, for sensing the inner temperature of the machine body.

The controller 700 is electrically connected to the electric heater 111, the motor mixer 113, the ambient temperature sensor 500, the inner temperature sensor 600, the water inlet control valve 210, the water inlet pressure sensor 220, the water inlet flow regulator 230, the cold-water inlet control valve 310, the cold-water inlet pressure sensor 320, the cold-water inlet flow regulator 330, and the water outlet control valve 410. The controller 700 can control actions of these elements programmatically, and is used for calculating the proportional relationship between the water 800 and the food 900 depending on the ambient temperature sensed by the ambient temperature sensor 500, and controlling the weight or volume of the water 800 incoming the accommodation reservoir 112 from the water inlet pipe 200 according to the proportional relationship and the weight or volume of the food 900. Moreover, the proportional relationship between the water 800 and the food 900 is inversely proportional to the temperature. That is, when the temperature is lower, the proportional relationship between the water 800 and the food 900 is higher; and when the temperature is higher, the proportional relationship between the water 800 and the food 900 is lower.

Also referring to FIG. 4, during usage, the controller 700 control the open time of the water inlet control valve 210 of the water inlet pipe 200 according to the ambient temperature sensed by the ambient temperature sensor 500, the weight or volume of the food 900 to be added, the inlet-water pressure value sensed by the water inlet pressure sensor 220 and the flow value of inlet water in the water inlet flow regulator 230 so as to further control the weight or volume of the water 800 incoming the accommodation reservoir 112 from the water inlet pipe 200. Thereafter, the controller 700 controls the electric heater 111 to execute heating of the water 800 until the water 800 is boiled for the first time.

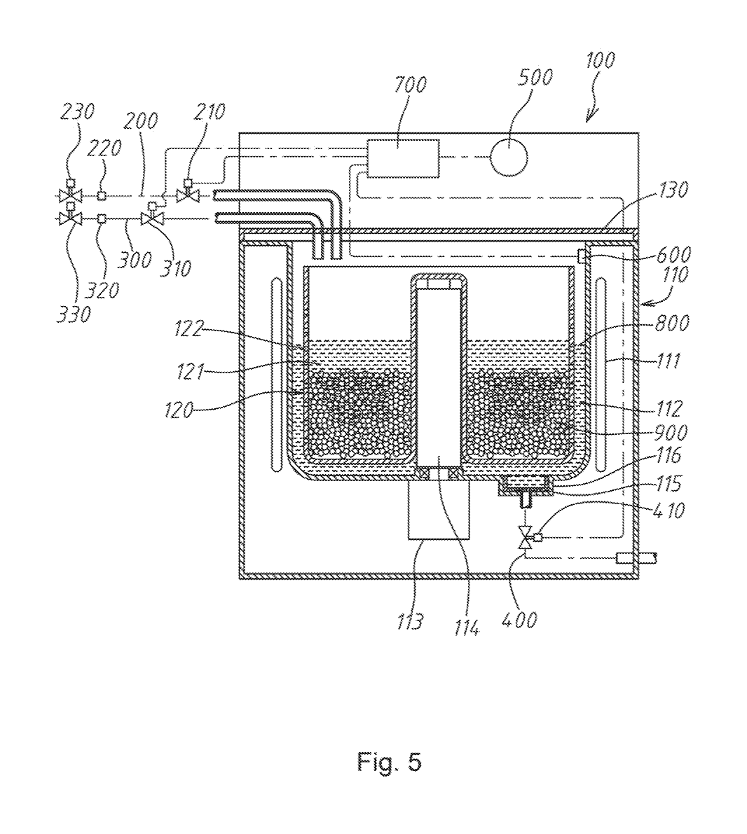

Also referring to FIG. 5, when the inner temperature sensor 600 senses that the inner temperature of the machine body 100 is 100° C. (i.e., the first boil of the water), the food 900 is put into the accommodation chamber 121 of the interior container 120. When the food 900 is put into the water boiled for the first time, the mixed temperature of the food and water is reduced, at this time the controller 700 controls the motor mixer 113 to rotate, and the electric heater 111 heats the water continuously, so that the heated water can heat the rotating food 900 uniformly through the through holes 122 until the water is heated to boil for the second time.

When the inner temperature sensor 600 again senses that the inner temperature of the machine body 100 is 100° C. (i.e., the second boil of ater), the temperature of the electric heater 111 is reduced so as to simmer the food 900 under the low temperature for a period of time (about 20 minutes).

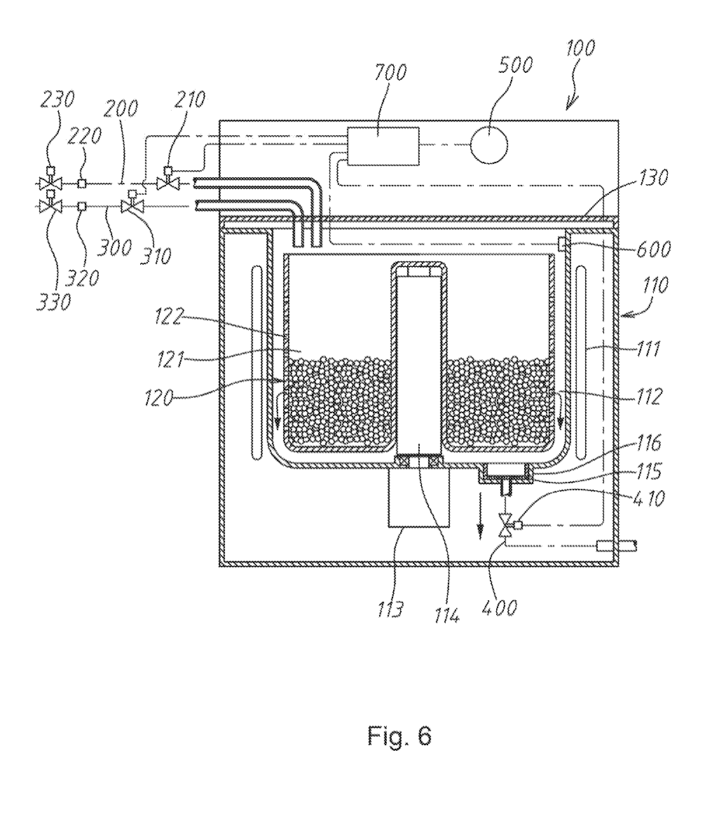

Also referring to FIG. 6, after the simmering is completed, the controller 700 controls water outlet control valve 410 of the water outlet pipe 400 to open, so as to evacuate the water 800 in the accommodation reservoir 112.

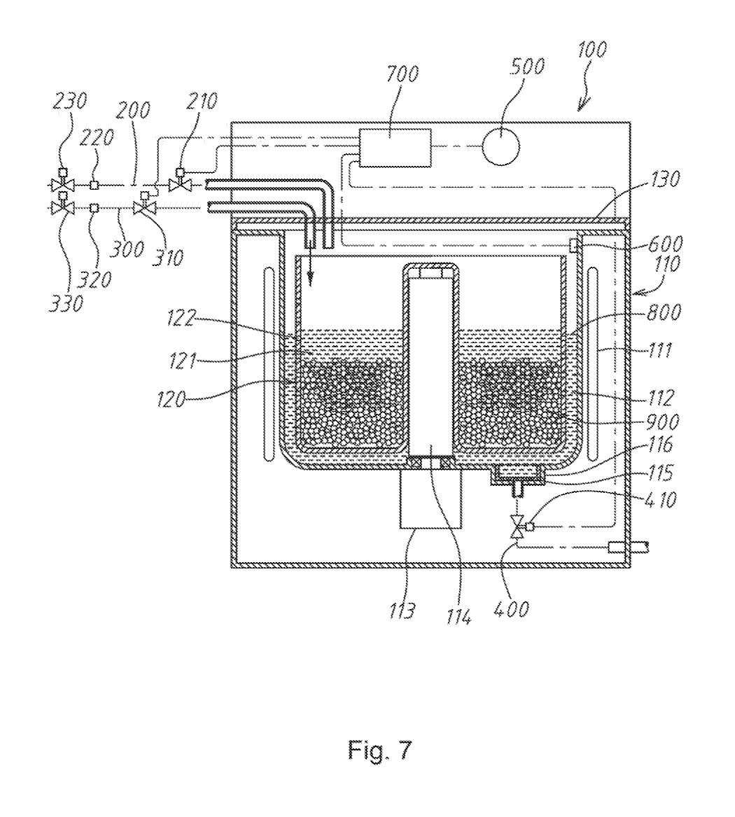

Also referring to FIG. 7, after the water evacuation is completed, the controller 700 controls the cold-water inlet control valve 310 of the cold water inlet pipe 300 to open, and controls the opening time of the cold-water inlet control valve 310 of the cold water inlet pipe 300 according to the cold-water inlet pressure sensed by the cold-water inlet pressure sensor 320 and the flow value of the inlet cold water in the cold-water inlet flow regulator 330, so as to inject an appropriate amount of cold water into the accommodation reservoir 112 to cool the fully-cooked food 900, making the food has appropriate hardness-softness taste (elastic degree). Thereafter, as shown in FIG. 6, the water is evacuated, and the interior container 120 is taken out to pour out the fully-cooked food after cooling.

The food cooking device of the invention is convenient in operation, and since the weight or volume of the water 800 incoming the accommodation reservoir 112 from the water inlet pipe 200 is determined depending on the proportional relationship between the water 800 and the food 900 calculated according to the ambient temperature sensed by the ambient temperature sensor 500, and depending on the weight or volume of the food 900, the mixed temperature can be maintained constant each time after the food is added into the water boiled for the first time, and then the heating time of food after the food and water are mixed and before the second boil of the water can be kept constant, so as to keep the same quality and taste of food for each cooking.

More particularly, for example, when the room ambient temperature sensed by the ambient temperature sensor 500 is 10° C., then as controlled by the controller 700, it can be seen that the proportional relationship between the water 800 and the food 900 is about 6; at this time if it is wanted to cook starchy or flour food (such as Tapioca balls) of three kilograms (kg), from the proportional relationship and the weight of the food 900, it can be calculated that the weight of the water 800 incoming the accommodation reservoir 112 from the water inlet pipe 200 is about 18 kg; and then when the food 900 of 3 kg is added into the water 800 of 18 kg which is boiled for the first time, the mixed temperature is about 84° C., so that the heating time of the food is the temperature rise time from 84° C. to 100° C. More particularly, for example, when the room ambient temperature sensed by the ambient temperature sensor 500 is 30° C., then as controlled by the controller 700, it can be seen that the proportional relationship between the water 800 and the food 900 is about 4.3; at this time if it is wanted to cook starchy or flour food (such as Tapioca balls) of three kilograms (kg), from the proportional relationship and the weight of the food 900, it can be calculated that the weight of the water 800 incoming the accommodation reservoir 112 from the water inlet pipe 200 is about 13 kg; and then when the food 900 of 3 kg is added into the water 800 of 13 kg which is boiled for the first time, the mixed temperature is about 84° C., so that the heating time of the food is the temperature rise time from 84° C. to 100° C.

That is, the food cooking device according to an embodiment of the invention is convenient in operation, and for a food required to be cooked by boiling water twice, the device can ensure the heating time of the food is constant and keep the same quality and taste of food for each cooking, not changing the heating time of the food due to the extremely significant varying of the room ambient temperature and avoiding affecting the quality and taste of the food.

Although the invention has been disclosed with reference to the above embodiments, these embodiments are not intended to limit the invention. It will be apparent to those of skills in the art that various modifications and variations can be made without departing from the spirit and scope of the invention. Hence, the scope of the invention shall be defined by the appended claims.

What is claimed is:

1. A food cooking device applied for cooking food by boiling water twice, comprising:
a machine body, comprising:
an enclosure provided with an electric heater on a wall body of the enclosure, wherein an accommodation reservoir is formed on an inner portion of the enclosure for accommodating the water, a motor mixer is disposed at a bottom of the enclosure, and the motor mixer has a mixing shaft vertically protruded towards a central portion of the accommodation reservoir; and
an interior container removably combined to the mixing shaft,
positioned in the accommodation reservoir, wherein an accommodation chamber is formed on the inner portion of the interior container for accommodating the food, and multiple through holes are formed on a wall body of the interior container and communicated with the accommodation reservoir and the accommodation chamber;
a water inlet pipe and a water inlet control valve thereof, communicated to the accommodation reservoir, for transferring the water into the accommodation reservoir;
an ambient temperature sensor disposed outside the machine body to sense a room ambient temperature;
an inner temperature sensor disposed in the machine body, for sensing a temperature in the machine body; and
a controller electrically connected to the electric heater, the motor mixer, the ambient temperature sensor, the inner temperature sensor and the water inlet control valve, for calculating the proportional relationship between the water and the food based on the ambient temperature, and controlling the weight or volume of the water entering the accommodation reservoir from the water inlet pipe according to the proportional relationship and the weight or volume of the food.

2. The food cooking device of claim 1, wherein the water inlet pipe is provided with a water inlet pressure sensor and a water inlet flow regulator, and the water inlet pressure sensor and the water inlet flow regulator are electrically connected to the controller.

3. The food cooking device of claim 1, wherein the water inlet pipe is a hot water inlet pipe.

4. The food cooking device of claim 1, further comprising a water outlet pipe and a water outlet control valve of the pipe, wherein the water outlet pipe is communicated with a bottom of the accommodation reservoir, and the water outlet control valve is electrically connected to the controller.

5. The food cooking device of claim 4, wherein a recess is arranged at the bottom of the accommodation reservoir and is communicated with the water outlet pipe, for accommodating a removable residue collecting container.

6. The food cooking device of claim 4, further comprising a cold water inlet pipe and a cold-water inlet control valve of the cold water inlet pipe, wherein the cold water inlet pipe is communicated with the accommodation reservoir, and the cold-water inlet control valve is electrically connected to the controller.

7. The food cooking device of claim 6, wherein the cold water inlet pipe is provided with a cold-water inlet pressure sensor and a cold-water inlet flow regulator, and the cold-water inlet pressure sensor and the cold-water inlet flow regulator are electrically connected to the controller.

8. The food cooking device of claim 1, wherein an openable lid body covers a top surface of the enclosure.
